(19) United States
(12) Patent Application Publication
(10) Pub. No.: US 2013/0169077 A1
(43) Pub. Date: Jul. 4, 2013

(54) ELECTRIC ROTARY MACHINE

(71) Applicant: DENSO CORPORATION, Kariya-city (JP)

(72) Inventor: Toshihiro TAKEI, Seto-shi (JP)

(73) Assignee: DENSO CORPORATION, Kariya-city (JP)

(21) Appl. No.: 13/729,589

(22) Filed: Dec. 28, 2012

(30) Foreign Application Priority Data
Dec. 28, 2011 (JP) 2011-289584

(51) Int. Cl. H02K 9/193

(52) U.S. Cl. CPC H02K 9/193
USPC 310/54

(57) ABSTRACT

An electric rotary machine has a motor frame having a cooling fluid passage, a rotary shaft rotatably supported by the motor frame, a rotor fixed to the rotary shaft, and a stator. The stator has a core having a ring shape and a stator winding wound around the core. The stator core is arranged to face an outer periphery of the rotor in a radial direction. An inlet section and an outlet section are formed in the motor frame. Cooling fluid is introduced into the cooling fluid passage through the inlet section and discharged from the outlet section. A partition wall section is formed on the motor frame and divides the cooling fluid passage into a cooling fluid inlet passage and a cooling fluid outlet passage. Through an opening formed in the partition wall section, the cooling fluid inlet passage and the cooling fluid outlet passage communicate with each other.

### CROSS-REFERENCE TO RELATED APPLICATION

This application is related to and claims priority from Japanese Patent Application No. 2011-289584 filed on Dec. 28, 2011, the contents of which are hereby incorporated by reference.

### BACKGROUND OF THE INVENTION

1. Field of the Invention

The present invention relates to electric rotary machines to be used as electric motors and electric generators in motor vehicles, etc.

2. Description of the Related Art

There is a conventional electric rotary machine which is widely known in general. Such an electric rotary machine is composed of a rotary shaft, a rotor and a stator. The rotary shaft is rotatably supported by a motor frame having a cylindrical shape. The rotor is fixed to the rotary shaft and arranged in the motor frame. The stator has a stator core and a stator winding. The stator core has a ring shape and is supported by the motor frame. The stator core is arranged at an outer periphery of the rotor to face the rotor in a radial direction of the rotor. The stator winding is wound around the stator core. For example, a first patent document, Japanese patent laid open publication No. JP 2001-15578, and a second patent document, Japanese patent laid open publication No. JP 2009-247085, disclose conventional electric rotary machines having a cooling fluid passage through which cooling fluid flows and cools the stator because the stator has a high temperature by heat energy when the electric rotary machine generates electric power or outputs an output torque thereof.

The first patent document discloses a conventional electric rotary machine having a first cylindrical member (a first motor frame), a second cylindrical member (a second motor frame) and a cooling fluid passage composed of a plurality of spiral shaped grooves. The stator is arranged in the inside of the first cylindrical member. The second cylindrical member is fitted to and fixed to the outer peripheral surface of the first cylindrical member. The spiral shaped grooves are spirally arranged between the first cylindrical member and the second cylindrical member. Cooling fluid flows through the spiral shaped grooves in order to cool the stator.

The second patent document discloses a conventional electric rotary machine having a bracket (a motor frame), a cooling fluid passage having a belt-like shape and a boundary wall or a partition wall section. The bracket is arranged at the outer periphery of the stator. The cooling fluid passage is arranged along the circumferential surface of the bracket. The boundary wall is extended in parallel to a rotary axis of the rotor so as to provide the cooling fluid into the overall cooling fluid passage in a circumferential direction thereof.

By the way, the first patent document uses the spiral shaped grooves, and intends to decrease a flow pressure of the cooling fluid generated in a single spiral shaped groove. However, it is not sufficient for the structure of the cooling fluid passage disclosed in the first patent document to adequately decrease the flow pressure of the cooling fluid of the spiral shaped grooves when a large amount of cooling fluid is supplied into the cooling fluid passage. The first patent document further has a drawback to increase the manufacturing cost because the structure of the spiral shaped grooves is requested to execute a complicated machining process. This increases the manufacturing cost.

The boundary wall, arranged in parallel to a rotary axis of the rotor disclosed in the second patent document, has a different temperature distribution from a temperature distribution of the cooling fluid which has the same speed in parallel to the rotary speed of the rotary shaft.

### SUMMARY

It is therefore desired to provide an electric rotary machine having a structure capable of flowing cooling fluid in a cooling fluid passage at a constant flow speed and uniformly cooling an entire stator by the cooling fluid.

To achieve the above purposes, the present exemplary embodiment provides an electric rotary machine having a stator, a rotor, and a motor frame. The rotor is arranged to face the stator. The motor frame has a cylindrical shape and supports the stator. In particular, an inlet section, an outlet section and a cooling fluid passage are formed in the motor frame. Cooling fluid is introduced into the cooling fluid passage through the inlet section. The cooling fluid is discharged to the outside of the electric rotary machine through the outlet section. The cooling fluid flows in the cooling fluid passage to cool the stator. A partition wall section is formed in the cooling fluid passage along a circumferential direction of the motor frame. The partition wall section divides the cooling fluid passage in an axial direction of the motor frame into a cooling fluid inlet passage and a cooling fluid outlet passage. Further, an opening section is formed in the partition wall section through which the cooling fluid inlet passage communicates with the cooling fluid outlet passage.

In the electric rotary machine having the above structure, the cooling fluid introduced into the inside of the cooling fluid inlet passage through the inlet section flows in the cooling fluid inlet passage, and flows into the cooling fluid outlet passage through the opening section. The cooling fluid is discharged through the outlet section to the outside of the cooling fluid passage. Thus, the cooling fluid introduced into the cooling fluid passage through the inlet section flows in the cooling fluid inlet passage and the cooling fluid outlet passage in order. The cooling fluid passage is divided into the cooling fluid inlet passage and the cooling fluid outlet passage by the partition wall section formed on the motor frame. This structure makes it possible to supply the cooling fluid having a uniform flow speed, and to uniformly cool the entire stator fixed to the motor frame. That is, according to the exemplary embodiment of the present invention, because the cooling fluid having a uniform flow speed in the cooling fluid passage can uniformly cool the entire stator, it is possible for the stator to have a uniform temperature distribution and to avoid the output torque of the electric rotary machine from being limited by a unstable temperature distribution of the stator. That is, the structure of the electric rotary machine according to the present invention can provide a stable output and a stable torque.

### BRIEF DESCRIPTION OF THE DRAWINGS

A preferred, non-limiting embodiment of the present invention will be described by way of example with reference to the accompanying drawings, in which:

FIG. 1 is a view showing a partial cross section of an upper half in an axial direction of an electric rotary machine according to a first exemplary embodiment of the present invention;

FIG. 2 is a perspective view of a first motor frame in the motor frame of the electric rotary machine according to the first exemplary embodiment shown in FIG. 1;

FIG. 3 is a perspective view of a second motor frame in the motor frame of the electric rotary machine according to the first exemplary embodiment shown in FIG. 1;

FIG. 4 is a view showing a relationship between a partition wall section composed of an inner partition wall section and an outer partition wall section, an opening section, an inlet section connected to an inlet pipe and an outlet section connected to an outlet pipe in the motor frame of the electric rotary machine according to the first exemplary embodiment of the present invention;

FIG. 5 is a view showing a cross section of a motor frame composed of a first motor frame having a partition wall section and a second motor frame in the electric rotary machine according to a first modification of the first exemplary embodiment of the present invention;

FIG. 6 is a view showing a cross section of a motor frame composed of a first motor frame and a second motor frame having a partition wall section in the electric rotary machine according to a second modification of the first exemplary embodiment of the present invention;

FIG. 7 is a view showing a cross section of a motor frame composed of a first motor frame having an inner partition wall section and a second motor frame having an outer partition wall section in the electric rotary machine according to a third modification of the first exemplary embodiment of the present invention;

FIG. 8A is a view showing a cross section of a first motor frame having an inner partition wall section with a meandered section in the electric rotary machine according to a fourth modification of the first exemplary embodiment of the present invention;

FIG. 8B is a view showing a relationship in position between the meandered section in the partition wall section, the inlet section and the outlet section in the electric rotary machine according to the fourth modification of the first exemplary embodiment of the present invention;

FIG. 8C is a view showing a cross section of the first motor frame and the second motor frame in the A-A line shown in FIG. 8B;

FIG. 9 is a view showing a partial cross section of an upper half section in an axial direction of an electric rotary machine according to a second exemplary embodiment of the present invention;

FIG. 10 is a perspective view of a first motor frame in an electric rotary machine according to a third exemplary embodiment;

FIG. 11 is a view showing one projection section having a triangular prism shape formed on the first motor frame in the electric rotary machine according to the third exemplary embodiment;

FIG. 12A is a perspective view showing a modification of each projection section having a semi-cylindrical shape used in the motor frame in the electric rotary machine according to the third exemplary embodiment;

FIG. 12B is a perspective view showing a modification of each projection section having a square prismatic shape used in the motor frame in the electric rotary machine according to the third exemplary embodiment; and

FIG. 13 is a cross section of the electric rotary machine according to a fourth exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

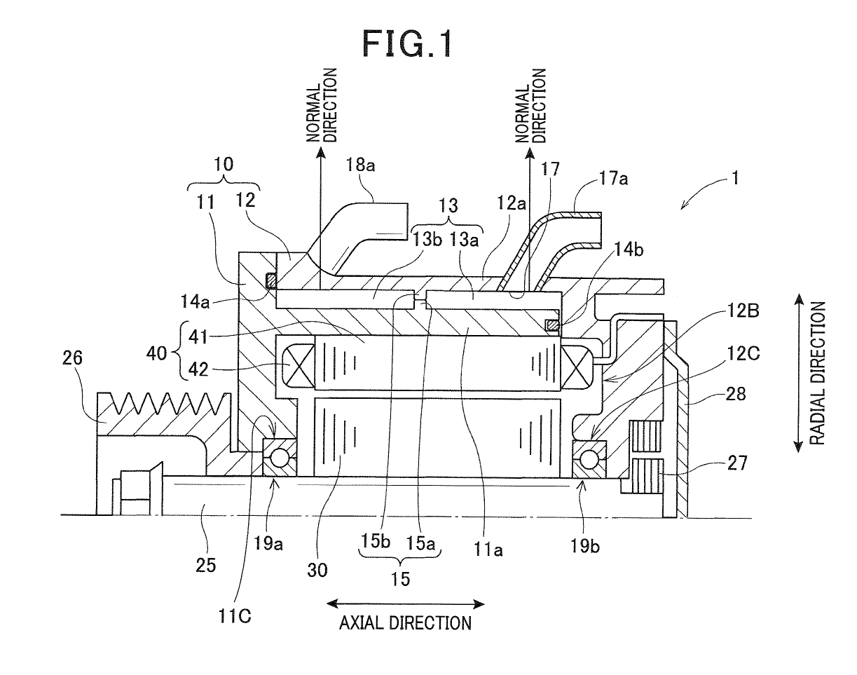

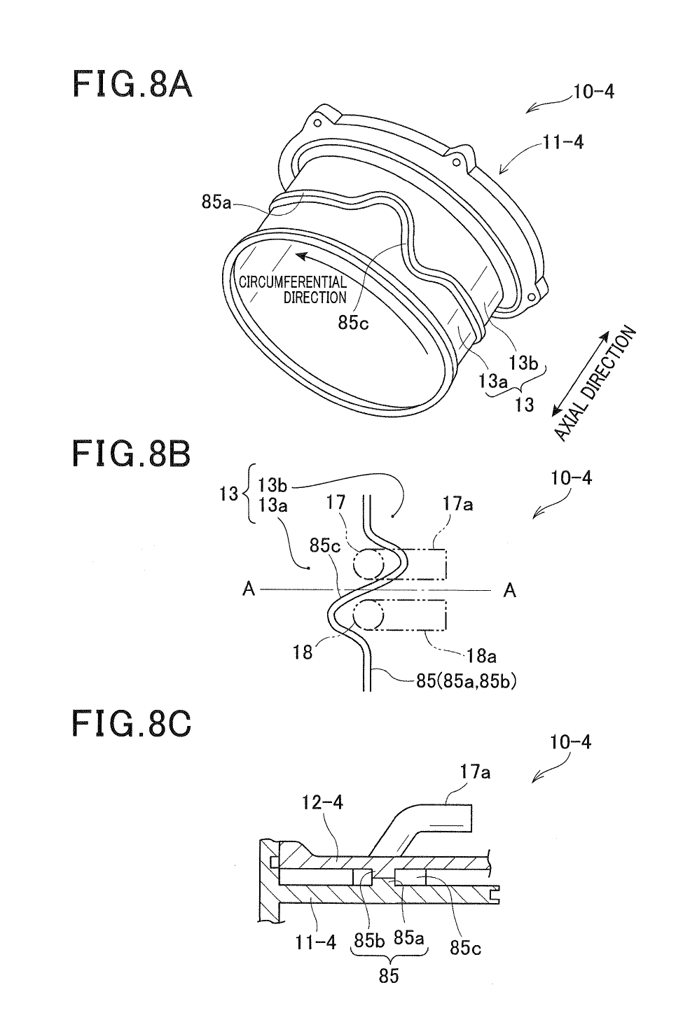

A description will now be given of an electric rotary machine 1 according to a first exemplary embodiment of the present invention with reference to FIG. 1 to FIG. 8A, FIG. 8B and FIG. 8C.

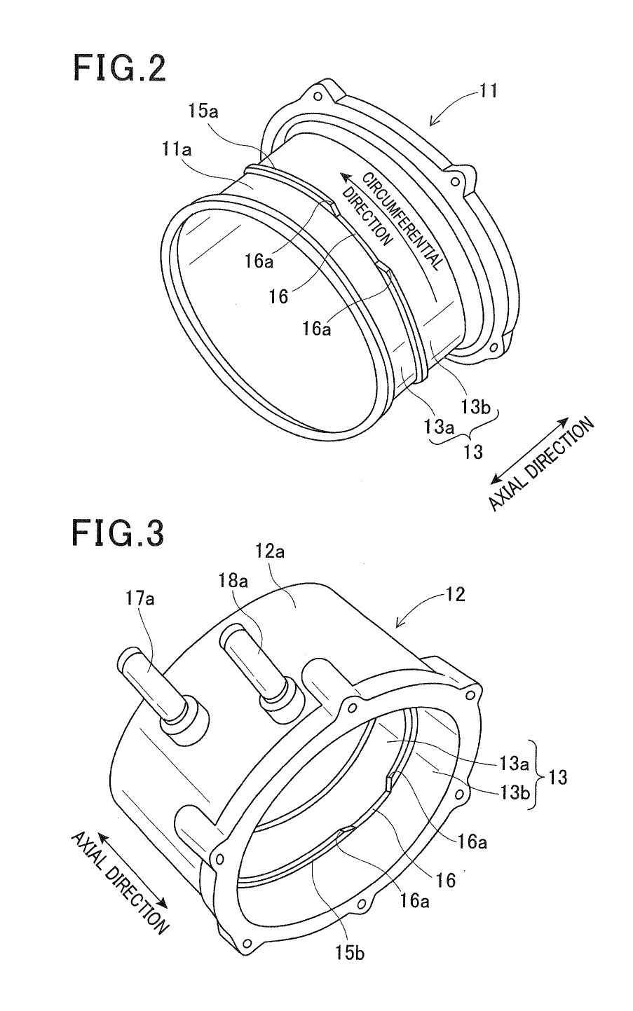

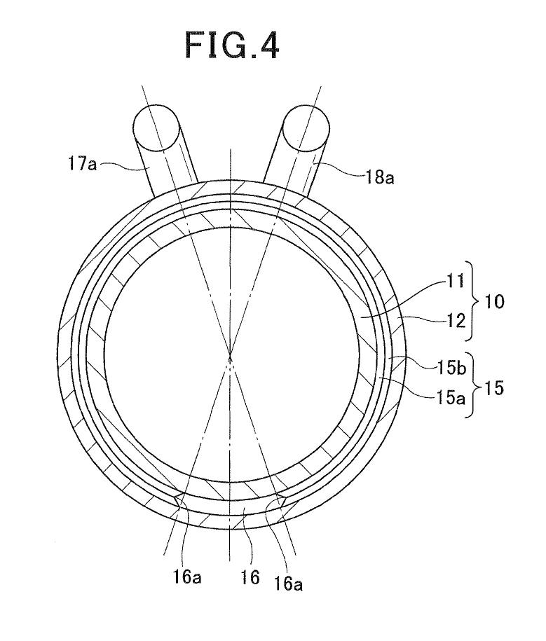

FIG. 1 is a view showing a partial cross section of an upper half of the electric rotary machine 1 in an axial direction according to the first exemplary embodiment of the present invention. FIG. 2 is a perspective view of a first motor frame 11 in the motor frame 10 of the electric rotary machine 1 according to the first exemplary embodiment shown in FIG. 1. FIG. 3 is a perspective view of a second motor frame 12 in the motor frame 10 of the electric rotary machine 1 according to the first exemplary embodiment shown in FIG. 1. FIG. 4 is a view showing a relationship between a partition wall section 15 composed of an inner partition wall section 15a and an outer partition wall section 15b, an opening section 16, an inlet section 17 connected to an inlet pipe 17a and an outlet section 18 connected to an outlet pipe 18a in the motor frame 10 of the electric rotary machine 1 according to the first exemplary embodiment of the present invention.

The electric rotary machine 1 according to the first exemplary embodiment is mounted to a motor vehicle, for example, and acts as an electric motor. As shown in FIG. 1, the electric rotary machine 1 is composed of the motor frame 10, the rotary shaft 25, the rotor 30 and the stator 40.

The motor frame 10 is composed of the first motor frame 11 and the second motor frame 12. A cooling fluid passage 13 is formed in the motor frame 10. The rotary shaft is supported by the motor frame 10 through a pair of bearings 19a and 19b. The rotor 30 is fitted to and engaged with an outer peripheral surface of the rotary shaft 25. The stator 40 has a stator core 41 and a stator winding 42. The stator core 41 has a ring shape arranged an outer periphery of the rotor 30. The stator winding 42 is wound around the stator core 41.

The motor frame 10 is composed of the first motor frame 11 and the second motor frame 12. The first motor frame 11 has a cylindrical shape with a bottom section. The first motor frame 11 has an inner cylindrical section 11a. One end of the inner cylindrical section 11a (at the right side in FIG. 1) in an axial direction of the first motor frame 11 is opened.

The second motor frame 12 has a cylindrical shape with a bottom section. The second motor frame 12 has an outer cylindrical section 12a. The other end (at the left side in FIG. 1) is opened.

In the structure of the motor frame 10, the first motor frame 11 is fitted to and engaged with the second motor frame 12 so that the outer cylindrical section 12a of the second motor frame 12 is arranged on the outer periphery of the inner cylindrical section 11a of the first motor frame 11 along an axial direction, and the opening section of the first motor frame 11 is arranged in opposite to the opening section of the second motor frame 12.

The first motor frame 11 and the second motor frame 12 are fastened to each other along a circumferential direction of the first motor frame 11 and the second motor frame 12 by a plurality of bolts.

The cooling fluid passage 13 is formed between the inner cylindrical section 11a of the first motor frame 11 and the outer cylindrical section 12a of the second motor frame 12 so that the cooling fluid passage 13 has a predetermined width and a ring shape along a circumferential direction of the first cylindrical section 11a and the outer cylindrical section 12a. As shown in FIG. 1, O-shaped seal rings 14a and 14b are arranged at both seal ends of the first motor frame 11 and the second motor frame 12 where the first motor frame 11 contacts with the second motor frame 12.

As shown in FIG. 1 to FIG. 4, the partition wall section 15 is formed at the middle position in the cooling fluid passage 13 in an axial direction. The partition wall section 15 divides the cooling fluid passage 13 into a cooling fluid inlet passage 13a and a cooling fluid outlet passage 13b. That is, the cooling fluid inlet passage 13a is formed at one side in an axial direction of the cooling fluid passage 13, and the cooling fluid inlet passage 13b is formed at the other side in the axial direction of the cooling fluid passage 13.

As shown in FIG. 1, FIG. 2 and FIG. 3, the partition wall section 15 is divided into the inner partition wall section 15a and the outer partition wall section 15b. The inner partition wall section 15a is projected on the outer peripheral surface of the first motor frame 11. The outer partition wall section 15b is projected on the inner peripheral surface of the second motor frame 12. When the first motor frame 11 and the second motor frame 12 are assembled, it is formed that the inner partition wall section 15a faces the outer partition wall section 15b. In other words, the front end surface of the inner partition wall section 15a projected on the outer peripheral surface of the first motor frame 11 faces the front end surface of the outer partition wall section 15b projected from the inner peripheral surface of the second motor frame 12.

The opening section 16 is formed at a predetermined portion in a circumferential direction in the partition wall section 13 so that the cooling fluid inlet passage 13a communicates with the cooling fluid outlet passage 13b through the opening section 16. That is, as shown in FIG. 2 and FIG. 3, the opening section 16 is a cutout section which is made by cutting one section in each of the inner partition wall section 15a and the outer partition wall section 15b. The opening section 16 has edge sections 16a. It is possible to use the edge sections 16 to execute the positioning of the first motor frame 11 and the second motor frame 12 or to fix the first motor frame 11 and the second motor frame 12 together during a manufacturing process. The partition wall section 15 and the opening section 16 are formed on a plane surface which crosses at right angles to an axial core of the motor frame 10.

As shown in FIG. 1, the inlet section 17 is formed at one end surface in an axial direction of the outer cylindrical section 12a of the second motor frame 12. The inlet section 17 communicates with the cooling fluid inlet passage 13a. The inlet section 17 is connected to the inlet pipe 17a. A cooling fluid supply device (not shown) such as a pump supplies cooling fluid into the cooling fluid inlet passage 13a through the inlet pipe 17a. Further, the outlet section 18 is formed at the other end surface in an axial direction of the outer cylindrical section 12a of the second motor frame 12. The outlet section 18 communicates with the cooling fluid outlet passage 13b. The outlet section 18 is connected to the outlet pipe 18a. The cooling fluid is discharged to the outside of the motor frame 10 through the outlet pipe 18a.

The cooling fluid having a high temperature discharged from the cooling fluid outlet passage 13b is cooled by a cooling apparatus (not shown). The cooling fluid cooled by the cooling apparatus is returned to the cooling fluid supply device (not shown) such as a pump, and introduced into the inside of the cooling fluid inlet passage 13a. That is, the cooling fluid inlet passage 13a, the cooling fluid outlet passage 13b, the inlet section 17, the inlet pipe 17a, the outlet section 18, the outlet pipe 18a, the cooling fluid supply device (not shown), the cooling apparatus (not shown), and etc. make a recirculation passage of the cooling fluid. The first exemplary embodiment uses a liquid solution which contains several percent of ethylene glycol. However, the concept of the present invention is not limited by using the liquid solution containing several percent of ethylene glycol. For example, it is possible to use AFT (automatic transmission fluid), etc.

The inlet section 17 and the outlet section 18 are formed at a different position in a circumferential direction on the circumferential surface of the second motor frame 12 of the motor frame 10 so that the inlet section 17 and the outlet section 18 face along a normal direction.

As shown in FIG. 4, the inlet pipe 17a formed on the inlet section 17 is different from the outlet pipe 18a formed on the outlet section 18 by approximately 40°. That is, the inlet section 17 is separated in position in a circumferential direction and an axial direction from the outlet section 18 by a predetermined distance.

The opening section 16 is formed in the inner partition wall section 15a and the outer partition wall section 15b of the partition wall section 15 at the middle position between the inlet section 17 and the outlet section 18 in a circumferential direction and in an axial direction of the second motor frame 12. As shown in FIG. 4, the first exemplary embodiment discloses the structure of the opening section 16 in which the opening section 16 is formed in the partition wall section 15 at the middle position of a long arc between the inlet section 17 and the outlet section 18 in a circumferential direction of the motor frame 10.

The circumferential length of the opening section 16 is determined so that the circumferential length of the opening section 16 is slightly longer than a distance in a circumferential direction between the center of the inlet section 17 and the center of the outlet section 18.

As shown in FIG. 1, a penetration hole 11c is formed in the center section of the bottom section 11b of the first motor frame 11. A front bearing 19a is fitted and arranged to the penetration hole 11c. The front bearing 19a is composed of an inner race, an outer race and a plurality of balls.

In addition, a cylindrical section 12c having a depression section is formed at the center section of the bottom section 12b of the second motor frame 12. The depression section of the cylindrical section 12c of the second motor frame 12 is opened toward the other side in an axial direction of the cylindrical section 12c. A rear bearing 19b is fitted and arranged into the cylindrical section 12c of the second motor frame 12. The rear bearing 19b is composed of an inner race, an outer race and a plurality of balls.

The both end sections of the rotary shaft 25 are inserted and fixed into the inner holes of the front bearing 19a and the rear bearing 19b, respectively. That is, the rotary shaft 25 is rotatably supported by the motor frame 10.

As shown in FIG. 1, the front end section at the other end of the rotary shaft 25 is projected extended from the front bearing 19a toward the other end along an axial direction, a pulley 26 is fixed to the outer peripheral surface of the front end part of the rotary shaft 25 by a nut 26a. A tension belt (not shown) is worn out between the pulley 26 and another pulley (not shown) of an external device. Through the tension belt, a torque of the rotary shaft 25 is transmitted.

The front end section of one end of the rotary shaft 25 is projected from the rear bearing 19b in an axial direction. A resolver 27 is arranged at the front end section of one end of the rotary shaft 25. The resolver 27 detects a rotation position of the rotary shaft 25. The resolver 27 is arranged in the inside of a rear cover 28.

The rotor 30 is fitted and fixed to the outer circumferential surface of the rotary shaft 25 at the center section in an axial direction of the rotary shaft 25. That is, the rotor 30 is arranged between the front bearing 19a and the rear bearing 19b. A plurality of magnetic poles is formed in the rotor 30 so that adjacent magnetic poles have a different polarity along a circumferential direction of the rotor 30 by a plurality of permanent magnets embedded in the outer circumferential section of the rotor 30. That is, the magnetic poles having a different magnetic polarity are alternately arranged in the rotor 30. The first exemplary embodiment discloses the rotor 30 having eight magnetic poles (North magnetic pole, N: four, and South magnetic pole is four, S: 4). The concept of the present invention is not limited by the number of the magnetic poles. It is possible for various types of electric rotary machines to have a different number of the magnetic poles.

The stator 40 is composed of the stator core 41 having a ring shape and the three phase stator winding 42. The stator core 41 is arranged in a radial direction in the motor frame 10 so that the stator core 41 is arranged on the outer periphery of the rotor 30 and faces the rotor 30 through a gap (or air gap) having a predetermined length. The stator winding 42 is wound around the stator core 41.

The stator core 41 has a plurality of slots arranged in a circumferential direction along an inner circumferential section of the stator core 41. Because the stator winding 42 in the electric rotary machine 1 according to the first exemplary embodiment is a distributing winding of double slots, one phase of the stator winding 42 uses two slots in the entire of 48 slots in the eight magnetic poles of the rotor 30. That is, there are 48 slots (8×3×2=48). An insulation paper (not shown) is inserted and arranged along an inner wall surface of each slot. The electric rotary machine according to the first exemplary embodiment uses rectangular conductive wires covered with an insulation film as the stator winding 42.

The stator 40 is fitted and fixed to the inside of the first motor frame 11. That is, the stator 40 is supported by the first motor frame 11. In the structure of the electric rotary machine 1 according to the first exemplary embodiment, the cooling fluid passage 13 formed in the motor frame 10 and the stator core 41 are arranged to be completely overlapped to each other in an axial direction. This structure makes it possible for the cooling fluid flowing through the cooling fluid passage 13 to uniformly cool the entire stator 40.

When alternating current (AC) electric power is supplied from an inverter (not shown) to the stator winding 42 in the electric rotary machine 1 according to the first exemplary embodiment having the structure previously described, the stator core 41 in the stator 40 is excited, and the rotor 30 fixed to the rotary shaft starts to rotate in a predetermined rotary direction. The torque of the rotary shaft 25 is transmitted to external devices (not shown) through the tension belt of the pulley 26.

At this time, cooling fluid is introduced into the inside of the cooling fluid inlet passage 13a from the inlet section 17 formed in the motor frame 10 by the cooling fluid supply device (not shown) mounted to the cooling fluid recirculation passage. The cooling fluid introduced into the cooling fluid inlet passage 13a in a normal direction thereof collides with the outer peripheral surface of the first motor frame 11, and the flow of the cooling fluid is then divided into both sides along a circumferential direction. The divided cooling fluid then flows to the opening section 16. The divided cooling fluid flows in a clockwise direction and a counter clockwise direction, and the flows finally collide with each other at the opening section 16. The cooling fluid flows toward in an axial direction, and the cooling fluid is discharged from the cooling fluid inlet passage 13a and the opening section 16 to the cooling fluid outlet passage 13b. Further, the cooling fluid is returned toward the outlet section 18 through the cooling fluid outlet passage 13b. The cooling fluid is then recirculated to the cooling fluid recirculation passage.

The cooling fluid passage 13, through which cooling fluid flows, is composed of the first cooling fluid passage and the second cooling fluid passage. In the first cooling fluid passage, the cooling fluid flows from the inlet section 17 through the cooling fluid inlet passage 13a in a clockwise direction, and is returned at the opening section 16, and then flows through the cooling fluid outlet passage 13b in a counterclockwise direction. In the second cooling fluid passage, the cooling fluid flows from the inlet section 17 through the cooling fluid inlet passage 13a in a counterclockwise direction, and is returned to the opening section 16, and then flows through the cooling fluid outlet passage 13b in a clockwise direction. The first cooling fluid passage and the second cooling fluid passage have the same length when measured along a circumferential direction of the motor frame 10 because the opening section 16 is formed at the middle position on a long arc section of the partition wall along a circumferential direction of the motor frame 10 between the inlet section 17 and the outlet section 18 in the cooling fluid passage 13. This structure of the first cooling fluid passage and the second cooling fluid passage makes it possible to uniformly cool the entire stator core 41 and the motor frame 10 supporting the stator core 41 with high efficiency, where a temperature of the stator core 41 is increased by heat energy generated in the stator winding 42.

The cooling fluid having a high temperature returned to the cooling fluid recirculation passage from the outlet section 18 is cooled by the cooling apparatus (not shown). After cooling the cooling fluid, the cooling fluid is then introduced from the inlet section 17 into the cooling fluid inlet passage 13a in order to cool the motor frame 10. As previously described, the cooling fluid is recirculated in the cooling fluid recirculation passage and the motor frame 10 and the stator 40 are cooled by the cooling fluid flowing in the cooling fluid passage 13.

As previously described in detail, in the electric rotary machine 1 according to the first exemplary embodiment, the partition wall section 15 is formed in the cooling fluid passage 13 formed in the motor frame 10. The partition wall section 15 divides the cooling fluid passage 13 in an axial direction of the motor frame 10 into the cooling fluid inlet passage 13a and the cooling fluid outlet passage 13b. Further, the opening section 16 is formed in the partition wall section 15. Through the opening section 16, the cooling fluid inlet passage 13a and the cooling fluid outlet passage 13b communicate with to each other. This structure makes it possible to supply the cooling fluid having a uniform flow speed flowing in the cooling fluid passage 13, and the cooling fluid having a uniform flow speed can thereby uniformly cool the entire stator 40 supported by the motor frame 10. That is, the cooling fluid having a uniform flow speed flowing in the cooling fluid passage 13 makes it possible to uniformly cool the entire stator 40. It is thereby possible to avoid an output torque of the electric rotary machine 1 from being limited when the stator 40 has not a uniform temperature distribution in which a part of the stator 40 has a high temperature and has an unbalanced temperature distribution, for example. The electric rotary machine 1 according to the first exemplary embodiment having the structure previously described can output a stable output torque.

Further, because the cooling fluid passage 13 through which cooling fluid is supplied is composed of the first motor frame 11 and the second motor frame 12 in the electric rotary machine 1 according to the first exemplary embodiment, it is possible to easily produce and assemble the first motor frame 11 and the second motor frame 12 in the motor frame 10, with which cooling fluid can flow at a uniform flow speed, with an adequately-wide processing margin by a die-casting method or a cutting method.

Still further, in the structure of the electric rotary machine according to the first exemplary embodiment, because the partition wall section 15 is composed of the inner partition wall section 15a formed on the first motor frame 11 and the outer partition wall section 15b formed on the second motor frame 12, it is possible to flow the cooling fluid at an uniform flow speed in the cooling fluid passage 13. This makes it possible to uniformly cool the entire stator 40.

Still further, in the structure of the electric rotary machine according to the first exemplary embodiment, it is formed so that the inner partition wall section 15a formed on the first motor frame 11 faces the outer partition wall section 15b formed on the second motor frame 12 to each other, this structure of the partition wall section 15 makes it possible to arrange the inner partition wall section 15a and the outer partition wall section 15b close to each other, and the structure of the partition wall section 15 makes it possible to prevent the cooling fluid from being leaked through various sections other than the opening section 16.

Still further, in the structure of the electric rotary machine according to the first exemplary embodiment, because the cooling fluid passage 13 is divided into the cooling fluid inlet passage 13a and the cooling fluid outlet passage 13b in an axial direction by the partition wall section 15, the cooling fluid inlet passage 13a and the cooling fluid outlet passage 13b are formed in parallel to each other in an axial direction. This structure of the cooling fluid passage 13 makes it possible to easily produce the inlet section 17 and the outlet section 18 in the cooling fluid inlet passage 13a or the cooling fluid outlet passage 13b. Still further, because the partition wall section 15 has a straight shape along a circumferential direction of the motor frame 10, it is possible to easily form the partition wall section 15.

Still further, in the structure of the electric rotary machine according to the first exemplary embodiment, because the inlet section 17 and the outlet section 18 are formed at a different circumferential direction on the motor frame 10, it is possible to avoid the inlet section 17 and the outlet section 18 from interference with the inlet pipe 17a, the outlet pipe 18a and hoses connected to the inlet section 17 and the outlet section 18.

Still further, in the structure of the electric rotary machine according to the first exemplary embodiment, because the opening section 16 formed in the partition wall section 15 is arranged at the middle position between the inlet section 17 and the outlet section 18 in the cooling fluid passage 13 formed in the motor frame 10, it is possible for the first cooling fluid passage and the second cooling fluid passage to have the same length. That is, in the first cooling fluid passage, the cooling fluid flows from the inlet section 17 through the cooling fluid inlet passage 13a in a clockwise direction, and is returned at the opening section 16, and then flows through the cooling fluid outlet passage 13b in a counterclockwise direction. In the second cooling fluid passage, the cooling fluid flows from the inlet section 17 through the cooling fluid inlet passage 13a in a counterclockwise direction, and is returned at the opening section 16, and then flows through the cooling fluid outlet passage 13b in a clockwise direction. This makes it possible for the first cooling fluid passage and the second cooling fluid passage to have the same pressure loss and the same distribution of the cooling fluid flow.

Still further, in the structure of the electric rotary machine according to the first exemplary embodiment, because the opening section 18 is formed at the middle position on a long arc between the inlet section 17 and the outlet section 18 along a circumferential direction of the motor frame 10, it is possible that the cooling fluid passage from the inlet section 17 to the opening section 16 and the cooling fluid passage from the opening section 16 to the outlet section 18 approximately have the same length. This structure makes it possible to uniformly cool the stator 40.

Furthermore, in the structure of the electric rotary machine according to the first exemplary embodiment, the inlet section 17 is formed at one end section of the motor frame 10 in an axial direction, and the outlet section 18 is formed at the other end section of the motor frame 10 in an axial direction, it is possible to supply the cooling fluid to the all of the cooling fluid inlet passage 13a and the cooling fluid outlet passage 13b, which are separated to each other in an axial direction by the partition wall section 15.

Still further, in the structure of the electric rotary machine according to the first exemplary embodiment, because the edge sections 16a are formed at both the ends, namely, the corners of the opening section 16 in the partition wall section 15, it is possible to use the edge portions 16a in a positioning process or as the fixed section during the manufacturing process of the electric rotary machine. This makes it also possible to increase the manufacturing efficiency.

In addition, each of the inlet section 17 and the outlet section 18 is formed in a normal direction on the motor frame 10, namely, formed to face a normal direction. This structure makes it possible to introduce the cooling fluid in a normal direction into the inside of the cooling fluid inlet passage 13a, and to provide a uniform amount of the cooling fluid into both directions, namely, into a clockwise direction and a counterclockwise direction along a circumferential direction of the motor frame 10. This structure makes it possible to flow the cooling fluid at a constant flow speed in the cooling fluid passage 13. This structure makes it therefore possible to uniformly cool the entire stator 40 supported by the motor frame 10.

Still further, because the partition wall section 15 and the opening section 16 are formed on a plane surface which crosses at right angles to the axial core of the motor frame 10, it is formed that the cooling fluid inlet passage 13a and the cooling fluid outlet passage 13b divided by the partition wall section 15 are formed along a circumferential direction. This structure makes it possible to form the cooling fluid inlet passage 13a and the cooling fluid outlet passage 13b in the overall circumferential section of the motor frame 10, and to uniformly cool the stator 40 in a circumferential direction thereof.

In the structure of the electric rotary machine 1 according to the first exemplary embodiment as previously described, the partition wall section 15 is divided in a radial direction of the stator 10. However, the concept of the present invention is not limited by this structure. It is possible for the electric rotary machine 1 to have various modifications of the partition wall section 15.

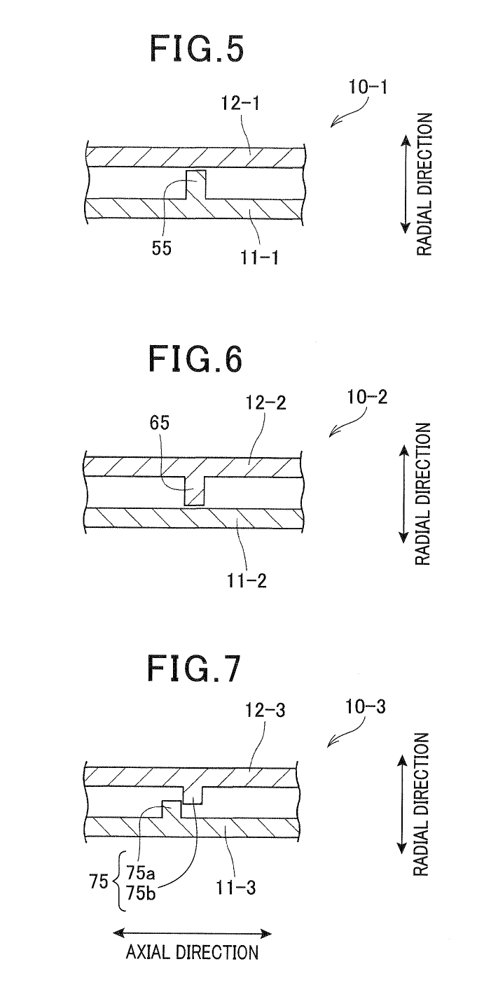

A description will be given of various types of the partition wall section 15 with reference to FIG. 5, FIG. 6, FIG. 7, FIG. 8A, FIG. 8B and FIG. 8C.

### First Modification

A description will now be given of a first modification of the partition wall section formed in the motor frame of the electric rotary machine with reference to FIG. 5.

FIG. 5 is a view showing a cross section of a motor frame 10-1 composed of a first motor frame 11-1 having a partition wall section 55 and a second motor frame 12-1 without a partition wall section in the electric rotary machine 1 according to a first modification of the first exemplary embodiment of the present invention.

As shown in FIG. 5, in the structure of the electric rotary machine 1 according to the first modification, the partition wall section 55 is formed on the first motor frame 11-1 only. That is, the second motor frame 12-1 has no partition section. Like the partition wall section 15 disclosed in the first exemplary embodiment previously described, the presence of the partition wall section 55 can provide cooling fluid having a uniform distribution of flow speed. That is, the structure of the motor frame 10-1 makes it possible to uniformly cool the stator 40, like the effects of the partition wall section 15 disclosed in the first exemplary embodiment.

In addition, it is possible to easily form the partition wall section 55 on the first motor frame 11-1 when compared with the production of the structure of the motor frame composed of the first motor frame having the partition wall section and the second motor frame having a partition wall section according to the first exemplary embodiment previously described.

### Second Modification

A description will now be given of a second modification of the partition wall section formed in the motor frame of the electric rotary machine 1 with reference to FIG. 6.

FIG. 6 is a view showing a cross section of a motor frame 10-2 composed of a first motor frame 11-2 and a second motor frame 12-2 having a partition wall section 65 in the electric rotary machine 1 according to a second modification of the first exemplary embodiment of the present invention.

As shown in FIG. 6, in the structure of the electric rotary machine 1 according to the second modification, the partition wall section 65 is formed on the second motor frame 12-2 only, not formed on the first motor frame 11-2. Like the partition wall section 15 disclosed in the first exemplary embodiment previously described, the presence of the partition wall section 65 can provide cooling fluid having a uniform distribution of flow speed. That is, the structure of the motor frame 10-2 makes it possible to uniformly cool the entire stator 40, like the effects of the partition wall section 15 disclosed in the first exemplary embodiment.

In addition, it is possible to easily produce the partition wall section 65 on the second motor frame 12-2 when compared with the production of the structure of the motor frame composed of the first motor frame having the partition wall section and the second motor frame having a partition wall section according to the first exemplary embodiment previously described.

### Third Modification

A description will now be given of a third modification of a partition wall section formed in the motor frame of the electric rotary machine with reference to FIG. 7.

FIG. 7 is a view showing a cross section of a motor frame 10-3 composed of a first motor frame 11-3 having an inner partition wall section 75a and a second motor frame 12-3 having an outer partition wall section 75b in the electric rotary machine 1 according to a third modification of the first exemplary embodiment of the present invention.

Like the structure of the partition wall section 15 composed of the inner partition wall section 15a and the outer partition wall section 15b disclosed in the first exemplary embodiment previously described, the partition wall section 75 is composed of the inner partition wall section 75a and the outer partition wall section 75b. As shown in FIG. 7, the inner partition wall section 75a is formed on the first motor frame 11-3, and the outer partition wall section 75b is formed on the second motor frame 12-3. That is, the partition wall section 75 is divided in a radial direction.

In particular, as shown in FIG. 7, the inner partition wall section 75a is arranged on the outer circumferential surface of the first motor frame 11-3. The outer partition wall section 75b is formed on the inner circumferential surface of the second motor frame 12-3. The inner partition wall section 75a and the outer partition wall section 75b are arranged slightly shifted to each other in an axial direction of the first motor frame 11-3 and the second motor frame 12-3. That is, in the partition wall section 75 according to the third modification, a side surface of the inner partition wall section 75a in an axial direction is adjacent and parallel to and closed to a side surface of the outer partition wall section 75b in an axial direction.

The presence of the partition wall section 75 having the inner partition wall section 75a and the outer partition wall section 75b can provide cooling fluid having a uniform distribution in flow speed. That is, the structure of the motor frame 10-3 makes it possible to uniformly cool the stator 40, like the effects of the partition wall section 15 disclosed in the first exemplary embodiment.

### Fourth Modification

A description will now be given of a fourth modification of the partition wall section formed in the motor frame of the electric rotary machine with reference to FIG. 8A, FIG. 8B and FIG. 8C.

FIG. 8A is a view showing a cross section of a first motor frame 11-4 having an inner partition wall section 85a with a meandered section 85c in the electric rotary machine 1 according to a fourth modification of the first exemplary embodiment of the present invention. FIG. 8B is a view showing a relationship in position between the meandered section 85c in the partition wall section 85, the inlet section 17 and the outlet section 18 in the electric rotary machine 1 according to the fourth modification of the first exemplary embodiment of the present invention. FIG. 8C is a view showing a cross section of the first motor frame 11-4 and the second motor frame 12-4 in the A-A line shown in FIG. 8B.

As previously described, the first exemplary embodiment, the first modification, the second modification and the third modification disclose the partition wall sections 15, 55, 65 and 75, respectively, which have the partition wall section having a straight shape formed on the motor frame in a circumferential direction of the motor frame.

On the other hand, as shown in FIG. 8A, the motor frame 10-4 according to the fourth modification has the first motor frame 11-4 and the second motor frame 12-4. The first motor frame 11-4 has the inner partition wall section 85a. The inner partition wall section 85a has the meandered section 85c which is curved once toward one end in an axial direction and is further curved once toward the other end in an axial direction. As shown in FIG. 8B, the presence of the meandered section 85c allows a part of the cooling fluid inlet passage 13a to be expanded toward the other side in an axial direction, and also allows a part of the cooling fluid outlet passage 13b to be expanded toward one side in an axial direction.

The inlet section 17 is formed at the position which corresponds in position to the expanded section of the cooling fluid inlet passage 13a in an axial direction, and the outlet section 18 is formed at the position which corresponds in position to the expanded section of the cooling fluid outlet passage 13b in an axial direction.

Like the partition wall section 15 according to the first exemplary embodiment, the partition wall section 85 according to the fourth modification is divided in a radial direction into the inner partition wall section 85a and the outer partition wall section 85b. The inner partition wall section 85a is projected from the outer circumferential surface of the first motor frame 11-4. The outer partition wall section 85b is projected from the inner circumferential surface of the second motor frame 12-4. The inner partition wall section 85a and the outer partition wall section 85b are arranged so that the projected front surface of the inner partition wall section 85a and the projected front surface of the outer partition wall section 85b are faced to each other in a radial direction.

The structure of the partition wall section 85 having the structure previously described makes it possible to allow the inlet section 17 and the outlet section 18 to be formed in the same axial direction in the motor frame 10-4.

### Second Exemplary Embodiment

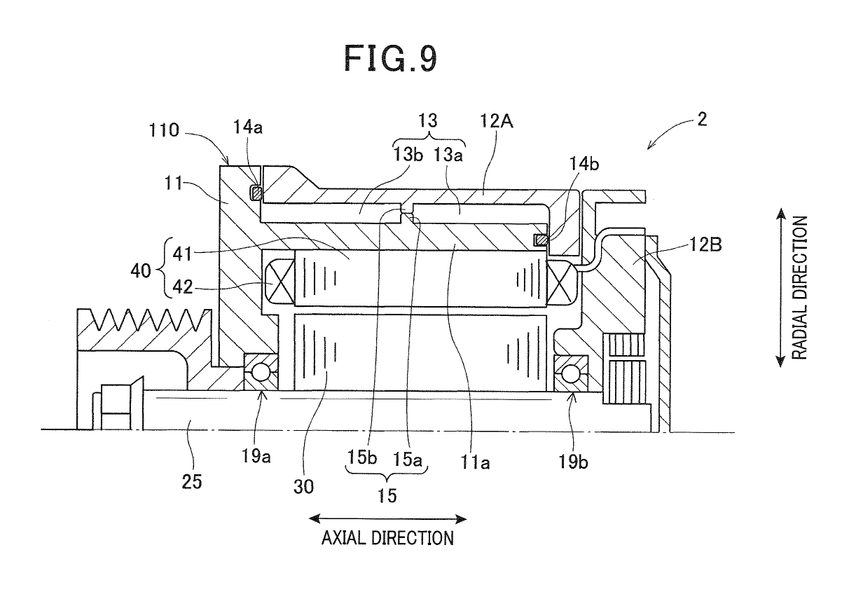

A description will be given of an electric rotary machine 2 according to a second exemplary embodiment of the present invention with reference to FIG. 9.

FIG. 9 is a view showing a partial cross section of an upper half section in an axial direction of the electric rotary machine 2 according to the second exemplary embodiment of the present invention.

In the structure of the electric rotary machine 1 according to the first exemplary embodiment previously described, the motor frame 10 is divided into the first motor frame 11 and the second motor frame 12.

On the other hand, as shown in FIG. 9, the electric rotary machine 2 according to the second exemplary embodiment has a motor frame 110 which is divided into three divided motor frames, namely, a first motor frame, a second motor frame and a third motor frame. The same components between the first exemplary embodiment and the second exemplary embodiment will be referred with the same reference numbers and characters. The explanation of the same components is omitted here for brevity.

The motor frame 110 is composed of the first motor frame 11, the second motor frame 12A and the third motor frame 12B. The first motor frame 11 in the motor frame 110 in the electric rotary machine 2 according to the second exemplary embodiment has the same structure of the motor frame 11 in the electric rotary machine 1 according to the first exemplary embodiment.

The second motor frame 12A and the third motor frame 12B used in the second exemplary embodiment are obtained by dividing the second motor frame 12 (according to the first exemplary embodiment) shown in FIG. 3 at a predetermined position into two sections.

In the structure of the electric rotary machine 2 according to the second exemplary embodiment, like the cooling fluid passage 13 disclosed in the first exemplary embodiment, the cooling fluid passage 13 is formed between the inner cylindrical section 11a of the first motor frame 11 and the second motor frame 12A, where the second motor frame 12A is fitted and fastened to the outer peripheral surface of the inner cylindrical section 11a.

Further, the cooling fluid passage 13 is divided into the cooling fluid inlet passage 13a at one side in an axial direction and the cooling fluid outlet passage 13b at the other side in an axial direction. Still further, the opening section 16 is formed in the partition wall section 15, like the partition wall section 15 disclosed in the first exemplary embodiment previously described.

According to the electric rotary machine 2 of the second exemplary embodiment, the partition wall section 15 is formed in the cooling fluid passage 13 and the opening section 16 is formed. The partition wall section 15 divides the cooling fluid passage 13 into the cooling fluid inlet passage 13a and the cooling fluid outlet passage 13b. The cooling fluid inlet passage 13a communicates with the cooling fluid outlet passage 13b through the opening section 16.

The structure of the electric rotary machine 2 according to the second exemplary embodiment makes it possible to make the cooling fluid having a uniform flow speed flowing through the cooling fluid passage 13, and thereby to uniformly cool the entire stator 40 supported by the motor frame 110. That is, the uniform flow speed of the cooling fluid flowing in the cooling fluid passage 13 makes it possible to uniformly cool the entire stator 40, like the same actions and effects obtained by the electric rotary machine 1 according to the first exemplary embodiment previously described.

### Third Exemplary Embodiment

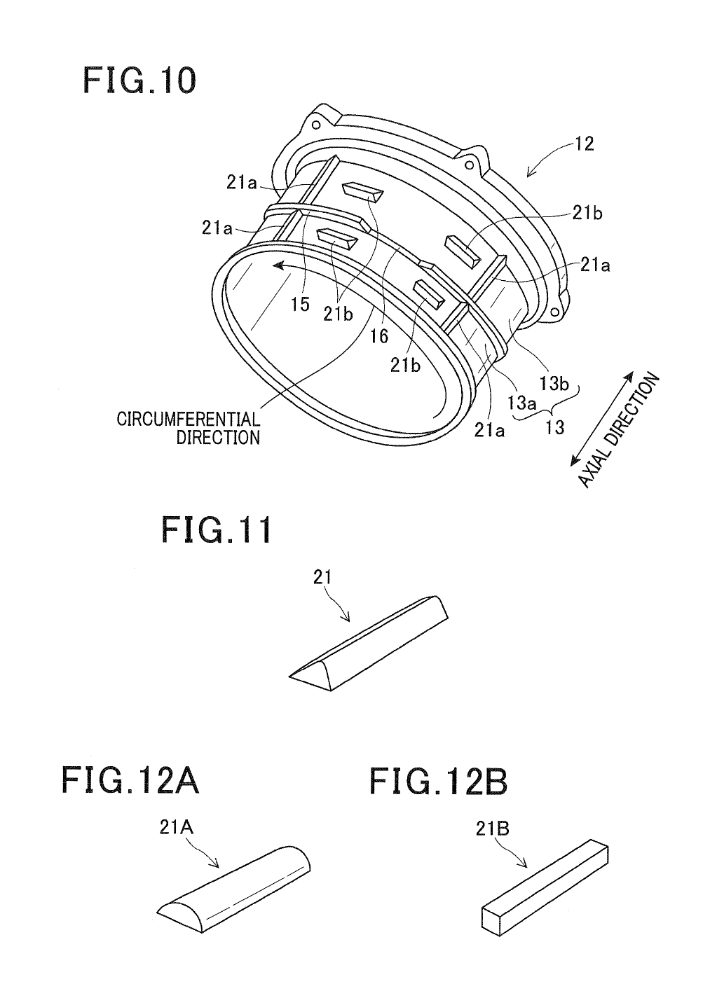

A description will be given of an electric rotary machine according to a third exemplary embodiment of the present invention with reference to FIG. 10, FIG. 11 and FIG. 12.

FIG. 10 is a perspective view of a first motor frame in an electric rotary machine according to the third exemplary embodiment of the present invention.

The entire structure of the electric rotary machine according to the third exemplary embodiment is omitted from FIG. 10. FIG. 10 shows the first motor frame 11-5 only for brevity and easy understanding.

FIG. 11 is a view showing projection sections 21 having a triangular prism shape formed on the outer circumferential surface of the first motor frame 11-5 in the electric rotary machine according to the third exemplary embodiment. The projection section 21 is composed of first projection members 21a and second projection members 21b. In particular, the third exemplary embodiment uses the projection section 21 formed in the first motor frame 11-5 shown in FIG. 11.

The same components between the first exemplary embodiment and the third exemplary embodiment will be referred with the same reference numbers and characters. The explanation of the same components is omitted here for brevity.

As shown in FIG. 10, the projection sections 21 are formed on the outer circumferential surface of the first motor frame 11-5. The outer circumferential surface of the first motor frame 11-5 is the surface which partitions the inside of the cooling fluid passage 13. The projection sections 21 are composed of the first projection members 21a and the second projection members 21b. The first projection members 21a are arranged to extend along an axial direction on the outer circumferential surface of the first motor frame 11-5. The second projection members 21b are arranged to extend along a circumferential direction on the outer circumferential surface of the first motor frame 11-5.

Each of the first projection members 21a extending along an axial direction and the second projection members 21b extending along a circumferential direction has a cross section having a triangle shape. Further, each of the first projection members 21a and the second projection members 21b has a height which is lower than the height of the inner partition wall section 15a formed on the first motor frame 11-5. The second motor frame 12 is omitted from FIG. 10. The second motor frame 12 in the electric rotary machine according to the third exemplary embodiment has the same structure of the second motor frame 12 in the electric rotary machine according to the first exemplary embodiment.

The first projection members 21a extending along an axial direction and the second projection members 21b extending along a circumferential direction do not prevent the cooling fluid flowing in the cooling fluid passage 13 formed in the motor frame 10-5 composed of the first motor frame 11-5 and the second motor frame 12. The first projection members 21a extending along an axial direction and the second projection members 21b extending along a circumferential direction can disturb the cooling fluid flowing in the cooling fluid passage 13.

In the electric rotary machine having the structure previously described according to the third exemplary embodiment, the projection sections 21 composed of the first projection members 21a and the second projection members 21b can disturb the flow of cooling fluid in the cooling fluid passage 13, it is possible to provide the cooling fluid to the overall cooling fluid passage 13. This makes it possible to uniformly cool the stator 40.

It is possible for the projection sections 21 to have various shapes.

FIG. 12A is a perspective view showing a modification of each projection section 21A having a semi-cylindrical shape used in the motor frame 10-5 in the electric rotary machine according to the third exemplary embodiment. That is, it is possible to use the projection section 21A having a semi-cylindrical shape in the motor frame 10-5 in the electric rotary machine.

FIG. 12B is a perspective view showing a modification of each projection section 21B having a square prism shape used in the motor frame 10-5 in the electric rotary machine according to the third exemplary embodiment. That is, it is possible to use the projection section 21B having a square prismatic shape in the motor frame 10-5 in the electric rotary machine.

Even if the projection sections 21, 21A or 21B shown in FIG. 11, FIG. 12A and FIG. 12B are formed on the outer circumference of the first motor frame 11-5, it is possible to disturb the flow of cooling fluid in the cooling fluid passage 13, and it is also possible to provide the cooling fluid to the overall cooling fluid passage 13. This makes it possible to uniformly cool the stator 40.

### Fourth Exemplary Embodiment

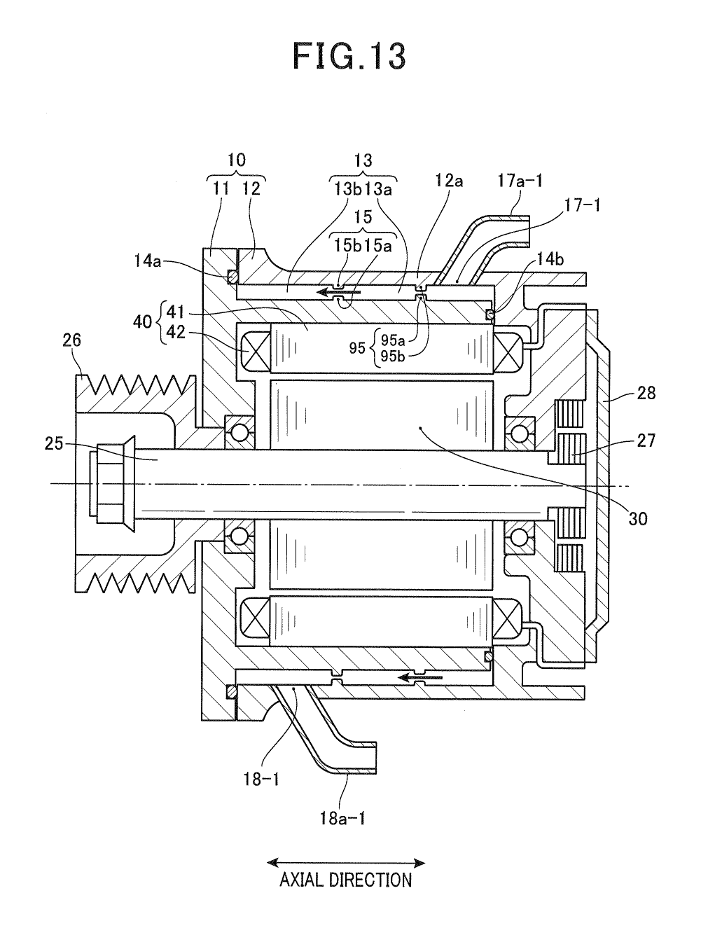

A description will be given of an electric rotary machine according to a fourth exemplary embodiment of the present invention with reference to FIG. 13.

FIG. 13 is a cross section of the electric rotary machine according to the fourth exemplary embodiment of the present invention.

For example, in the structure of the electric rotary machine 1 according to the first exemplary embodiment, the inlet section 17 and the outlet section 18 are formed on the position shifted to each other in phase by approximately 40 degrees in a circumferential direction of the motor frame 10. However, the concept of the present invention is not limited by the structure of the first exemplary embodiment.

For example, it is acceptable to form an inlet section having an area and an outlet section having an area so that the position of the inlet section and the position of the outlet section are formed in the motor frame at positions which are axially symmetric. This structure makes it possible to certainly avoid interference with hoses and pipes and connected to the inlet section and the outlet section.

For example, as shown in FIG. 13, the position of the inlet section 17-1 and the position of the outlet section 18-1 are formed in an opposite position shifted in a circumferential direction by approximately 180 degrees in the second motor frame 12 of the motor frame 10. The inlet pipe 17a-1 is connected to the inlet section 17-1 formed in the second motor frame 12 of the motor frame 10, and the outlet pipe 18a-1 is connected to the outlet section 18-1 formed in the second motor frame 12 of the motor frame 10.

Further, the structure of the electric rotary machine according to the fourth exemplary embodiment has a second partition wall section 95 in addition to the partition wall section 15. The partition wall section 15 is composed of the inner partition wall section 15a and the outer partition wall section 15b, like the partition wall section 15 disclosed in the first exemplary embodiment as previously described. Further, the partition wall section 95 is composed of an inner partition wall section 95a and an outer partition wall section 95b. The partition wall section 15 and the partition wall section 95 are formed on the frame 10 along a circumferential direction thereof, and arranged in parallel in an axial direction of the frame 10. Each of the partition wall section 15 and the partition wall section 95 is divided in a radial direction of the frame 10 into the inner partition wall section 15a, 95a and the outer partition wall section 15b, 95b. This structure shown in FIG. 13 makes it possible to certainly avoid interference with hoses or pipes connected to the inlet section 17 and the outlet section 18.

Further, in the structure of the electric rotary machine 1 according to the first exemplary embodiment, the inlet section 17 and the outlet section 18 are formed at a different position in a circumferential direction of the motor frame 10, and the opening section 16 is formed at the middle position in a circumferential direction between the inlet section 17 and the outlet section 18. However, the concept of the present invention is not limited by the structure of the first exemplary embodiment. For example, it is acceptable to form the inlet section 17 and the outlet section 18 in the same circumferential surface of the motor frame 10, and further to form the opening section 16 at the position which is axially symmetric to the inlet section 17 and the outlet section 18. This makes it possible that the cooling fluid inlet passage 13a from the inlet section 17 to the outlet section 18 has the same length of the cooling fluid outlet passage 13b from the opening section 16 to the outlet section 18. This structure of the motor frame in the electric rotary machine makes it also possible to uniformly cool the stator 40 by the cooling fluid flowing in the cooling fluid passage 13. The present invention provides the electric rotary machine having improved, increased and ideal cooling capability for the stator thereof.

### Other Features and Effects of the Present Invention

In the electric rotary machine as another aspect of the present invention, the motor frame is composed of a first motor frame and a second motor frame. The second motor frame is fitted and fastened to an outer periphery of the first motor frame. The cooling fluid passage is formed between the first motor frame and the second motor frame.

According to the present invention, because the first motor frame and the second motor frame form the cooling fluid passage, it is possible to easily produce the cooling fluid passage by using a die-casting method or a cutting method with a wide processing margin. The produced cooling fluid passage allows cooling fluid to have a uniform flow speed and a uniform temperature distribution

In the electric rotary machine as another aspect of the present invention, the partition wall section is formed on one of the first motor frame and the second motor frame.

According to the present invention, the presence of the partition wall section formed on the motor frame makes it possible to flow cooling fluid having a uniform distribution of flow speed and to uniformly cool the entire stator. In addition to this feature, it is possible to easily form the partition wall section on the motor frame when compared with a case in which the partition wall section is formed on each of the first motor frame and the second motor frame.

In the electric rotary machine as another aspect of the present invention, the partition wall section is formed on each of the first motor frame and the second motor frame.

This structure of the partition wall section formed on each of the first motor frame and the second motor frame makes it possible to supply cooling fluid having a uniform distribution in flow speed and to uniformly cool the entire stator.

In the electric rotary machine as another aspect of the present invention, the partition wall section of the first motor frame and the partition wall section of the second motor frame are formed at a position to be faced to each other.

According to the present invention, because the surface of the partition wall section formed on the first motor frame is closed to and face the surface of the partition wall section formed on the second motor frame, it is possible to prevent cooling fluid from being leaked between the both passages in the cooling fluid passage partitioned by the partition wall section, excepting the opening section.

In the electric rotary machine as another aspect of the present invention, the inlet section and the outlet section are formed at a different position in an axial direction of the motor frame. The partition wall section divides the cooling fluid passage into the cooling fluid inlet passage and the cooling fluid outlet passage in an axial direction of the motor frame.

According to the present invention, because the cooling fluid passage is divided into the cooling fluid inlet passage and the cooling fluid outlet passage in an axial direction by the partition wall section, the cooling fluid inlet passage and the cooling fluid outlet passage are formed in parallel to each other in an axial direction of the motor frame. This makes it possible to easily determine the position in the motor frame where the inlet section and the outlet section are formed. In addition, because the partition wall section can be formed in a straight shape with a simple structure along a circumferential direction of the motor frame, it is possible to easily form the partition wall section on the motor frame.

In the electric rotary machine as another aspect of the present invention, the inlet section and the outlet section are formed at a different position in a circumferential direction of the motor frame. The opening section is formed at a middle position between the inlet section and the outlet section of the cooling fluid passage in a circumferential direction of the motor frame.

According to the present invention, because the opening section is formed at the middle position in a circumferential direction between the inlet section and the outlet section, it is possible for each of the cooling fluid passages to have the same length even if the cooling fluid passage is divided into a plurality of passages and cooling fluid flows through any divided cooling flow passage. This structure makes it possible for each of the divided cooling flow passages to have the same pressure loss and a uniform distribution of flow speed. In addition, because the inlet section and the outlet section are formed at a different position in a circumferential direction of the motor frame, it is possible to eliminate any interference with horses and pipes connected to the inlet section and the outlet section.

In the electric rotary machine as another aspect of the present invention, the opening section is formed in the partition wall section at a middle position on an arc section having a long arc length between the inlet section and the outlet section in a circumferential direction of the motor frame.

According to the present invention, it is possible that the cooling fluid inlet passage from the inlet section to the opening section has the same length of the cooling fluid outlet passage from the opening section to the outlet section when compared with a case in which the opening section is formed on a short arc section in a circumferential direction between the inlet section and the outlet section formed in the motor frame. This structure makes it possible to uniformly cool the stator by the cooling fluid having a uniform temperature distribution.

In the electric rotary machine as another aspect of the present invention, the inlet section and the outlet section are formed in the motor frame at positions which are axially symmetric on the motor frame.

According to the present invention, it is possible to surely avoid any interference with horses and pipes connected to the inlet section and the outlet section of the motor frame. The positions which are axially symmetric in the motor frame having a cylindrical shape indicates that the positions in a circumferential direction of the motor frame having a cylindrical shape are separated from each other by 180° in phase in a circumferential direction of the motor frame. It is not always necessary for the center of each of the inlet section and the outlet section to be formed at positions which are axially symmetric, but it is sufficient that a part of the inlet section and a part of the outlet section are formed at positions which are axially symmetric.

In the electric rotary machine as another aspect of the present invention, the inlet section and the outlet section are formed at the same side in a circumferential direction of the motor frame. The opening section is formed in the partition wall section at positions which are axially symmetric to the inlet section and the outlet section formed in the motor frame.

According to the present invention, the cooling fluid inlet passage from the inlet section to the opening section has the same passage length of the cooling fluid outlet passage from the opening section to the outlet section. This structure makes it possible to uniform cool the entire stator. The present invention provides an ideal cooling for the stator.

Further, the positions which are axially symmetric in the cooling fluid passage formed in the motor frame indicate that the positions in a circumferential direction of the motor frame having a cylindrical shape are separated from the inlet section and the outlet section by 180° in phase in a circumferential direction of the motor frame. It is not always for the center of each of the opening sections to form the position which is axially symmetric, but necessary that a part in the opening section is formed at a position which is axially symmetric.

In the electric rotary machine as another aspect of the present invention, the inlet section is formed at one end of the motor frame in a rotary shaft of the rotor. The outlet section is formed at the other end of the motor frame in the rotary shaft of the rotor.

According to the present invention, it is possible to supply cooling fluid to the overall cooling fluid passages divided and separated in an axial direction of the motor frame to each other by the partition wall section.

In the electric rotary machine as another aspect of the present invention, edge parts are formed at both sides of the opening section formed in the partition wall section.

According to the present invention, because the edge sections are formed on the partition wall section which is formed extending along a circumferential direction of the motor frame having a cylindrical shape, it is possible to use the edge sections during a positioning process and to use the edge sections as fixing member during a manufacturing process for producing electric rotary machines. This makes it possible to increase the manufacturing efficiency.

In the electric rotary machine as another aspect of the present invention, each of the inlet section and the outlet section is formed in a normal direction on a surface of the motor frame.

According to the present invention, because the cooling fluid is introduced in a normal direction of the motor frame into the cooling fluid inlet passage through the inlet section, when the cooling fluid introduced in the cooling fluid inlet passage collides with the inner wall of the motor frame which forms the inner circumferential surface of the cooling flow passage, the cooling fluid having the same quantity introduced in the cooling fluid inlet passage is divided and branched and supplied into both sides of the cooling flow passage. This makes it possible for the cooling fluid to have the same flow speed in the cooling flow passage and to uniformly cool the entire stator supported by the motor frame.

In the electric rotary machine as another aspect of the present invention, the partition wall section and the opening section are formed on a surface of the motor frame along a circumferential direction which crosses at right angles to the axial core of the motor frame.

According to the present invention, the partition wall section and the opening section are formed on the surface which crosses at right angles to the axial core of the motor frame. This makes it possible to form the cooling fluid inlet passage and the cooling fluid outlet passage to be extended along a circumferential direction of the motor frame. This makes it possible to form the inlet passage and the cooling fluid outlet passage on the whole circumference of the motor frame and thereby to uniformly cool the entire stator along a circumferential direction of the motor frame.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. An electric rotary machine comprising:
a stator;
a rotor arranged to face the stator; and
a motor frame having a cylindrical shape to support the stator, wherein
an inlet section, an outlet section and a cooling fluid passage are formed in the motor frame, cooling fluid is introduced into the cooling fluid passage through the inlet section, the cooling fluid is discharged through the outlet section, and the cooling fluid cools the stator,
a partition wall section is formed in the cooling fluid passage along a circumferential direction of the motor frame, the partition wall section divides the cooling fluid passage in an axial direction of the motor frame into a cooling fluid inlet passage and a cooling fluid outlet passage, and an opening section is formed in the partition wall section through which the cooling fluid inlet passage communicates with the cooling fluid outlet passage.

2. The electric rotary machine according to claim 1, wherein
the motor frame is composed of a first motor frame and a second motor frame, the second motor frame is fitted and fastened to an outer periphery of the first motor frame, and the cooling fluid passage is formed between the first motor frame and the second motor frame.

3. The electric rotary machine according to claim 2, wherein
the partition wall section is formed on one of the first motor frame and the second motor frame.

4. The electric rotary machine according to claim 2, wherein
the partition wall section is formed on each of the first motor frame and the second motor frame.

5. The electric rotary machine according to claim 4, wherein
the partition wall section of the first motor frame and the partition wall section of the second motor frame are formed at a position to face to each other.

6. The electric rotary machine according to claim 1, wherein
the inlet section and the outlet section are formed at a different position in an axial direction of the motor frame, and the partition wall section divides the cooling fluid passage into the cooling fluid inlet passage and the cooling fluid outlet passage in an axial direction of the motor frame.

7. The electric rotary machine according to claim 1, wherein
the inlet section and the outlet section are formed at a different position in a circumferential direction of the motor frame, and the opening section is formed at a middle position between the inlet section and the outlet section of the cooling fluid passage in a circumferential direction of the motor frame

8. The electric rotary machine according to claim 7, wherein
the opening section is formed in the partition wall section at a middle position on an arc section having a long arc length between the inlet section and the outlet section in a circumferential direction of the motor frame.

9. The electric rotary machine according to claim 7, wherein
the inlet section and the outlet section are formed in the motor frame at positions which are axially symmetric.

10. The electric rotary machine according to claim 1, wherein
the inlet section and the outlet section are formed at the same side in a circumferential direction of the motor frame, and the opening section is formed in the partition wall section at a position which is axially symmetric to the inlet section and the outlet section formed in the motor frame.

11. The electric rotary machine according to claim 1, wherein
the inlet section is formed at one end of the motor frame in a rotary shaft of the rotor, and the outlet section is formed at the other end of the motor frame in the rotary shaft of the rotor.

12. The electric rotary machine according to claim 1, wherein
edge parts are formed at both sides of the opening section formed in the partition wall section.

13. The electric rotary machine according to claim 1, wherein
each of the inlet section and the outlet section is formed in a normal direction on a surface of the motor frame.

14. The electric rotary machine according to claim 1, wherein
the partition wall section and the opening section are formed on a surface of the motor frame along a circumferential direction which crosses at right angles to an axial core of the motor frame.
